(19) United States
(12) Patent Application Publication
(10) Pub. No.: US 2011/0111375 A1
(43) Pub. Date: May 12, 2011

(54) Messaging Device Having Braille Output

(75) Inventors: Adrianne Binh Luu, Roswell, GA (US); Mark Edward Causey, Tucker, GA (US); Michael Robert Zubas, Marietta, GA (US)

(73) Assignee: AT&T MOBILITY II LLC, Atlanta, GA (US)

(21) Appl. No.: 12/616,219

(22) Filed: Nov. 11, 2009

(51) Int. Cl. G09B 21/02

(52) U.S. Cl. 434/114

(57) ABSTRACT

A Braille cell is incorporated within a messaging device. The Braille cell may be defined on a portion of a keypad, a touchscreen, or a navigation pad. An alphanumeric string, such as a text message, is transcribed into Braille. A resulting Braille character or contraction is represented on the Braille cell via actuators coupled to the keypad, touchscreen, or navigation pad. The actuators mechanically raise, lower, or vibrate to correspond to active bits in the Braille character. A tactile sensation is therefore experienced by the user.

### BACKGROUND OF THE INVENTION

1. Field of the Invention

The present invention relates to messaging devices. More particularly, the present invention relates to displaying Braille output on messaging devices.

2. Background of the Invention

Messaging devices, such as cellular telephones, have become tremendously popular. It is estimated that there were 4.1 billion cellular phone subscriptions at the end of 2008. Close to 80% of the world now enjoys cellular coverage, a figure only increasing as new networks appear. Along with the abundance of cellular telephones comes the demand for new and improved services. It is no longer enough to just place and receive calls, users want it all.

With the pervasive use of messaging devices, these devices are being used in all aspects of life. Not only are messaging devices used for communicating; they have also become mobile computers. These devices allow user to send, receive, and read text messages, e-mails, web pages, documents, etc. However, current devices require that a user view a screen to read text from these media. This may not be possible for sight-impaired users.

Braille is system of characters widely used by sight-impaired individuals. A Braille character, or cell, is made up of six dot positions, or bits, arranged in a rectangle containing two columns of three dots each. A bit may be raised at any of the six positions to form sixty-four permutations, including the arrangement in which no bits are raised. Braille characters represent the characters of a writing system, contractions of the characters, or symbols. Braille allows sight-impaired individuals to read messages, much like printed text.

What is needed is a messaging device that displays Braille such that the device can be used by a sight-impaired user.

### SUMMARY OF THE INVENTION

The present invention addresses the above-identified issues by incorporating a Braille cell within a messaging device. The Braille cell may be defined on a portion of a keypad, a touchscreen, or a navigation pad. An alphanumeric string, such as a text message, is transcribed into Braille. A resulting Braille character or contraction is represented on the Braille cell via actuators coupled to the keypad, touchscreen, or navigation pad. The actuators mechanically raise, lower, or vibrate to correspond to active bits in the Braille character. A tactile sensation is therefore experienced by the user. The alphanumeric string can be retrieved from a text message, e-mail, website, document, or an alphanumeric transcription of an audio file such as a voicemail.

In one exemplary embodiment, the present invention is a messaging device including a processor, a memory in communication with the processor, a plurality of keys on a keypad in communication with the processor, an actuator coupled to each of the plurality of keys, and a Braille display logic on the memory. The Braille display logic defines the plurality of keys as a Braille cell, each key representing a bit of the Braille cell, and actuates a key corresponding to an active bit of a Braille character.

In another exemplary embodiment, the present invention is a method for displaying Braille on a messaging device having a keypad, the method including defining a Braille cell on the keypad, each key on the keypad representing a bit of the Braille cell, and actuating a key corresponding to an active bit of a Braille character.

In yet another exemplary embodiment, the present invention is a system for displaying Braille. The system includes a network, a source device on the network, the source device having an alphanumeric string, a messaging device on the network, the messaging device including a plurality of keys on a keypad and an actuator coupled to each of the plurality of keys, and Braille messaging logic on the messaging device that retrieves the alphanumeric string, transcribes a Braille character from the alphanumeric string, defines the plurality of keys as a Braille cell, and actuates a key corresponding to an active bit of the Braille character.

### BRIEF DESCRIPTION OF THE DRAWINGS

FIGS. 1A and 1B show a messaging device 100 for displaying Braille, according to an exemplary embodiment of the present invention.

FIGS. 2A-2D show actuated keys of a messaging device, according to exemplary embodiments of the present invention.

FIG. 3 shows a method for displaying Braille on a messaging device, according to an exemplary embodiment of the present invention.

FIG. 4 shows a system for displaying Braille, according to an exemplary embodiment of the present invention.

FIGS. 5A-5B show a messaging device with a Braille cell on a keypad, according to an exemplary embodiment of the present invention.

FIG. 6 shows a Braille transcription on a virtual keypad of a messaging device, according to an exemplary embodiment of the present invention.

FIG. 7 shows a Braille transcription on a Braille cell region on a touchscreen of a messaging device, according to an exemplary embodiment of the present invention.

FIG. 8 shows a Braille cell on a navigation pad of a messaging device, according to an exemplary embodiment of the present invention.

FIGS. 9A-9B show the elements of a navigation pad on a messaging device, according to an exemplary embodiment of the present invention.

FIG. 10 shows a messaging device with multiple Braille cells defined on a QWERTY keyboard, according to an exemplary embodiment of the present invention.

### DETAILED DESCRIPTION OF THE INVENTION

The following detailed description discloses devices, systems, and methods for displaying Braille on a messaging device. A messaging device has defined thereupon a Braille cell. The Braille cell may be defined on a portion of a keypad, a touchscreen, or a navigation pad. An alphanumeric string, such as a text message, is transcribed into Braille. A resulting Braille character or contraction is represented on the Braille cell via actuators coupled to the keypad, touchscreen, or navigation pad. The actuators mechanically raise, lower, or vibrate to correspond to active bits in the Braille character. A tactile sensation is therefore experienced by the user.

“Messaging device”, as used herein and throughout this disclosure, refers to any device having at least a processor, a memory with logic stored therein, and a keypad in communication with the processor. A messaging device also includes a transceiver that enables a user of the device to communicate over a network. Examples of messaging devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

“Logic” as used herein and throughout this disclosure, refers to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

Messaging devices communicate with each other and with other elements via a network, for instance, a wireless network, or a wireline network. A “network” can include broadband wide-area networks or local-area networks. Communication across a network is preferably packet-based; however, radio and frequency/amplitude modulations networks can enable communication between communication devices using appropriate analog-digital-analog converters and other elements. Examples of radio networks include Wi-Fi and BLUETOOTH® networks, with communication being enabled by hardware elements called “transceivers.” A network typically includes a plurality of elements that host logic for performing tasks on the network. In modern packet-based wide-area networks, servers may be placed at several logical points on the network. Servers may further be in communication with databases and can enable communication devices to access the contents of a database.

A keypad is a set of buttons or “keys” arranged in a block or a grid. The keys usually bear alphanumeric characters and other symbols, and are typically used as input devices. A keypad includes a full size keyboard, such as a QWERTY keyboard. A keypad also includes a virtual keypad or keyboard, such as the type displayed on a touchscreen. Keys within a keypad are coupled to mechanical “actuators.” An actuator is a mechanical device for moving or controlling a mechanism or system. An actuator includes transducers, motors, pneumatic actuators, hydraulic pistons, piezoelectric actuators, electroactive polymers, etc. An actuator moves a key on the keypad outwards (elevation), inwards (depression), or vibrates the key. In the case of a virtual keypad, the touchscreen may be equipped with actuators to vary the position of the “virtual keys” on the virtual keypad.

The purpose of an actuator is to enable a plurality of keys on a keypad to represent a Braille cell. Each Braille cell is made up of six or eight dot positions, arranged in a rectangle or grid, containing two columns of three or four dots each. Any dot may be raised at any of the positions to form several arrangements or permutations, wherein a single arrangement or permutation represents a character or combination of characters. A character-by-character transcription is known as Grade 1 Braille. Grade 2 Braille uses a system of contractions to reduce space and speed up the reading process. Therefore combinations of characters, portions of words, or entire words can be contracted to a single Braille character. Grade 3 Braille includes many additional contractions. As with most languages, the meanings of Braille characters and contractions are context-sensitive. A Braille character is formed from a combination of raised dots within a Braille cell. Each dot in a Braille cell represents a “bit” and a raised dot in a Braille character is an “active bit.” Therefore, an actuator coupled to a key on the keypad enables the key to correspond to an active bit. Consequently, the plurality of keys in a Braille cell corresponds to a 6-bit or 8-bit Braille character.

The actuated keys can be sensed by a user's fingers, thereby enabling the user to read a Braille transcription of an alphanumeric string on the messaging device. The alphanumeric string may be a portion of a message received at the messaging device. The message may be any one of a text message, short message service (SMS) message, or an e-mail. Alternatively, the alphanumeric string can be a portion of text retrieved from a website hosted on a remote server, or a portion of a document. Alphanumeric strings are not limited to Latin letters and Arabic numbers, but can include symbols and logos found in other languages.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

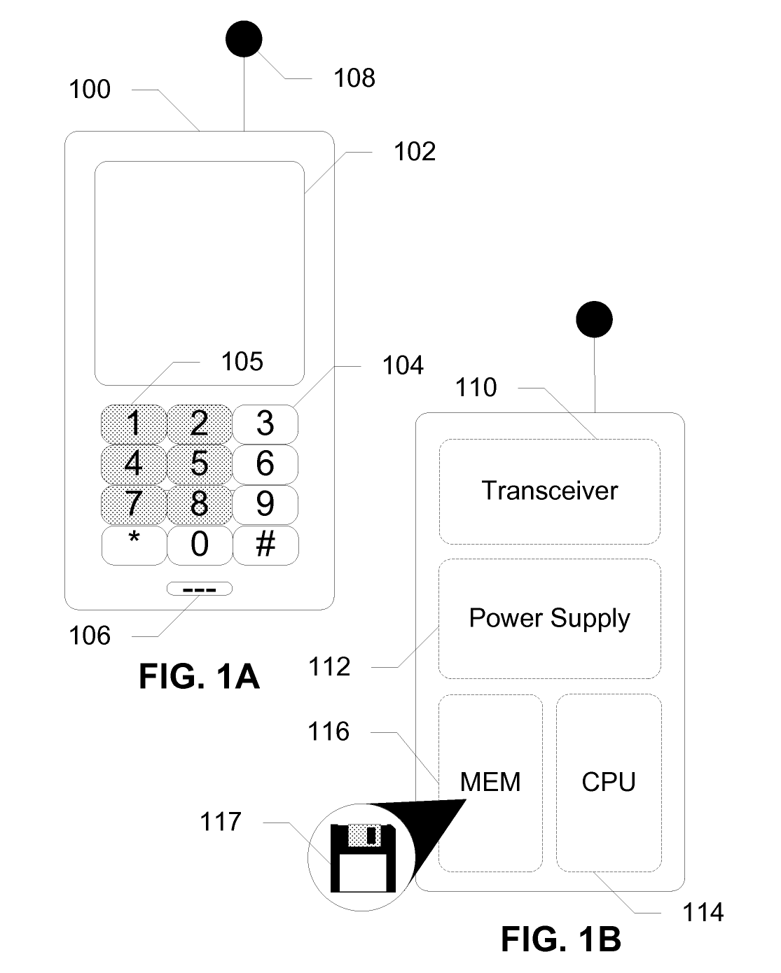

FIGS. 1A and 1B show a messaging device 100 for displaying Braille, according to an exemplary embodiment of the present invention. Referring to FIG. 1A, messaging device 100 includes a screen 102, a keypad 104 including keys 105, a microphone 106, and an antenna 108. With reference to FIG. 1B, inner components of messaging device 100 include a transceiver 110, a power supply 112, a central processing unit (CPU) 114, and a memory 116. Memory 116 includes Braille display logic 117 stored therein.

Screen 102 is an LCD or LED screen on which a user can view selections, numbers, letters, etc. Screen 102 can also be a touchscreen. Microphone 106 allows the user to verbally communicate with others using messaging device 100. Microphone 106 may further be used as a command input, for instance, to detect voice commands by a user. Antenna 108 is a transducer designed to transmit or receive electromagnetic waves to and from a network. In conjunction with antenna 108, transceiver 110 allows messaging device 100 to wirelessly communicate with a network, or with other wireless devices. Power supply 112 provides power to each of the components of messaging device 100, and can include a battery, as well as an interface to an external power supply. CPU 114 controls components of messaging device 100 according to instructions in logic stored on memory 116, such as Braille display logic 117. Braille display logic 117 contains instructions for defining a Braille cell on keypad 104, with one key 105 representing one bit of the Braille cell. Defining the Braille cell includes arranging the Braille cell across a grid of keys of keypad 104. Braille display logic 117 further contains instructions for actuating keys of the Braille cell corresponding to active bits. Transcription logic on memory 116 transcribes an alphanumeric string, such as a text or email received via transceiver 110, into Braille characters. Braille display logic 117 also contains instructions for advancing to the next Braille character when transcribing an alphanumeric string.

Keypad 104 is typically used as an input device, for instance, to type a phone number or a message. Keypad 104 also allows the user to read messages transcribed to Braille via the Braille cell of keypad 104. A plurality of keys 105 on keypad 104 is configured, by Braille display logic 117, to simulate a Braille cell as described above. Any set of six or eight keys 105 of keypad 104 can be grouped together, for instance, in two columns of three to four keys each. In this embodiment, the shaded keys 1, 4, 7, and 2, 5, and 8 constitute bits of a six-bit Braille cell. The six keys are able to elevate, depress, or vibrate, using actuators coupled to the keys. The actuated keys represent active bits of a Braille character, sensed by a finger of a sight-impaired user while reading a message.

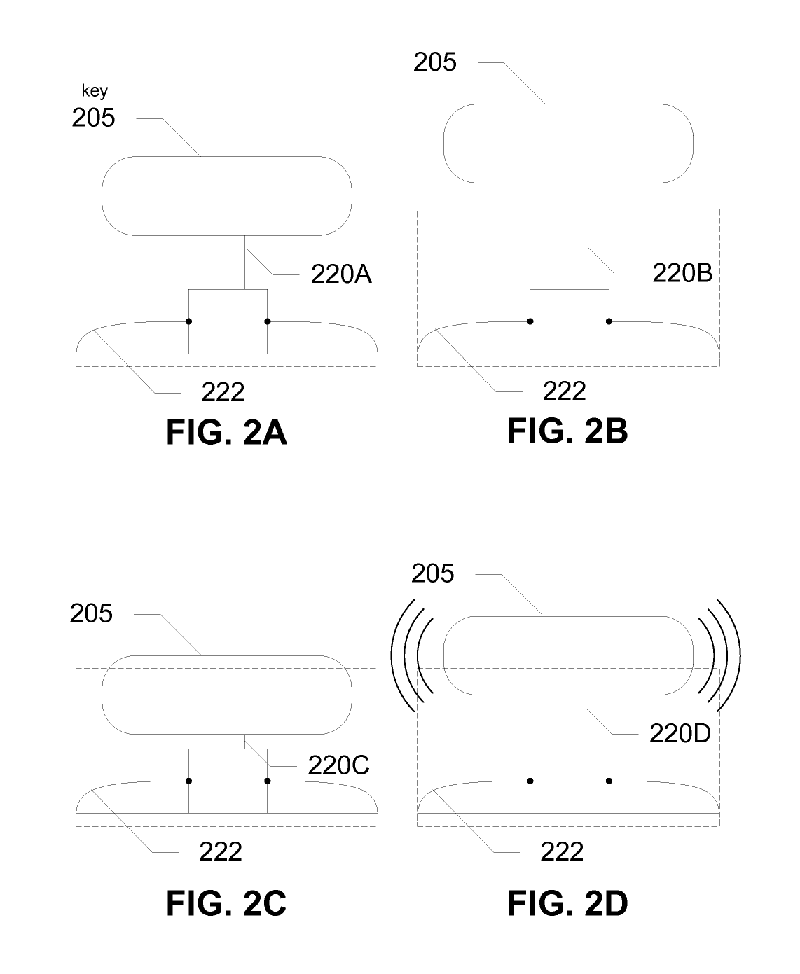

FIGS. 2A-2D show actuated keys of a messaging device, according to exemplary embodiments of the present invention. In these embodiments, the position of each key is altered by an actuator coupled to the key. These actuators server to elevate, lower, and/or vibrate the keys.

FIG. 2A shows a neutral position of a key 205 of a messaging device, according to an exemplary embodiment of the present invention. In this embodiment, key 205 is coupled to an actuator 220A. Actuator 220A receives commands in the form of signals transmitted via a signaling wire 222. The commands may be in the form of an electrical signal that is transmitted from a central processing unit (CPU) in communication with Braille display logic stored on a memory. Signaling wire 222 transmits signals that power actuator 220A such that key 205 moves up, moves down, vibrates, etc. In this embodiment, key 205 is in a neutral position; hence it represents an inactive or a passive bit of a Braille character.

FIG. 2B shows an elevated key 205 of a messaging device, according to an exemplary embodiment of the present invention. In this embodiment, key 205 is coupled to an elevating actuator 220B. Elevating actuator 220B elevates key 205 according to instructions from Braille display logic, delivered via a signaling wire 222. The signal enables actuator 220B to elevate key 205 with respect to the initial or neutral position of FIG. 205. Therefore, key 205 represents an active bit of a Braille character, and can be sensed by a fingertip of a sight-impaired user of the messaging device.

FIG. 2C shows a key 205 of a messaging device depressed by a lowering actuator 220C, according to an exemplary embodiment of the present invention. In this embodiment, key 205 is coupled to lowering actuator 220C. Lowering actuator 220C may be the same as the elevating actuator of FIG. 2B, or a different type of actuator. Instructions from a Braille display logic are delivered via signaling wire 222, which enable lowering actuator 220C to lower key 205 with respect to a neutral or elevated position. For instance, key 205 corresponds to an inactive or passive bit of a Braille character, while other keys corresponding to active bits may remain in a neutral position. Therefore a sight-impaired user loses tactile sensation of key 205 relative to the other keys, and can read the Braille character accordingly.

FIG. 2D shows a vibrating key 205 of a messaging device, according to an exemplary embodiment of the present invention. In this embodiment, key 205 is coupled to a vibrating actuator 220D. Vibrating actuator 220D vibrates according to commands from a central processing unit (CPU). These commands control the frequency and amplitude of the vibration of vibrating actuator 220D. These commands are delivered in the form of electrical signals from the CPU that are sent through a signaling wire 222 coupled to vibrating actuator 220D. Key 205 corresponds to an active bit of a Braille character. Consequently, a sight-impaired user can sense the vibrating keys of a Braille cell, including vibrating key 205, with respect to other stationary keys corresponding to inactive or passive bits, thereby being able to read the Braille character.

The actuating mechanisms of FIGS. 2A-2D are not mutually exclusive, and can be used in any practical combination. For instance, keys corresponding to active bits can vibrate in addition to being elevated, based on a user preference for easier reading. Alternatively, keys corresponding to active bits can vibrate while keys corresponding to passive bits can be depressed. Other combinations are possible and will become apparent to one of ordinary skill in the art.

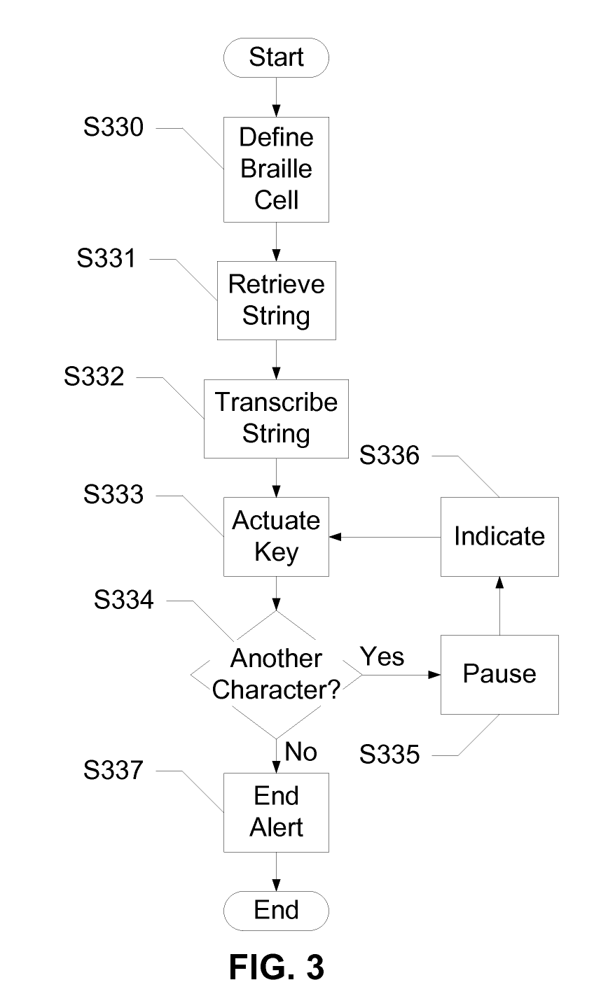

FIG. 3 shows a method for displaying Braille on a messaging device, according to an exemplary embodiment of the present invention. In this embodiment, logic on the messaging device defines a Braille cell S330. The defining includes grouping keys from a keypad of the messaging device into columns of three to four keys each. The keypad may be a virtual keypad on a touchscreen. Each key represents a bit of the Braille cell and an actuator coupled to the key enables an actuated key to represent an active bit of a Braille character. The defining S330 further includes defining a region on a touchscreen as corresponding to a Braille cell, wherein actuators arranged in a grid or matrix underneath the touchscreen can be used to represent bits of the Braille cell. The defining S330 can also include defining a Braille cell on a navigation pad on the messaging device, the navigation pad including a plurality of pins coupled to actuators, wherein an actuated pin represents an active bit of the Braille cell.

At S331, the messaging device retrieves an alphanumeric string via a network, for instance from another messaging device, or from a server on the network hosting a document or a website. At S332, the messaging device transcribes the alphanumeric string into Braille characters. The transcription S332 includes transcribing portions of the alphanumeric string into a Braille contraction. The portions include sequences of alphanumeric characters, symbols, or entire words. The active bits of each Braille character are represented by actuating S333 the Braille cell. For instance, a plurality of keys on the keypad are actuated such that they move up, move down, vibrate, etc., in order to create the appropriate Braille character. A virtual key on a virtual keypad may be raised, or have its texture changed by the actuators coupled to the touchscreen. A Braille cell defined on a region of a touchscreen can represent a Braille character by one or more actuators underneath the touchscreen. Alternatively, the pins of a navigation pad on the messaging device can be actuated S333 to represent the bits of the Braille character.

After the first Braille character is displayed, it is determined whether or not there is a next Braille character S334. If there is a next Braille character, the method pauses at the previous Braille character S335, and then indicates that the next Braille character is being displayed S336. After the indication or command to advance, the appropriate actuators create the next Braille character S333. When it is finally determined that there are not any more Braille characters from the transcribed alphanumeric message, the user is alerted of the end of the message S337. This alert may be a vibration, sound, etc., but is preferably not the same as the indication of a next Braille character.

An indication of a progression or advancement to the subsequent Braille character includes displaying a blank Braille cell having all inactive bits, or via a vibration or sound indicating that the next character is about to be displayed. Other means for indicating the progression to a new character or word will be evident to one skilled in the art in light of this disclosure. Thus, even if the next character is the same as the previous, such as for a double ‘e’, the user knows that the next Braille character is being displayed. The method also allows for a user to manually advance the transcription to the next letter or word. For instance, after reading a first Braille character, the user may push a button or state a voice command to advance the transcription to the subsequent Braille character. Other combinations of automatic and manual advancement are possible. Different combinations of progressions can be indicated differently, such as advancing from one contraction to another, one word to another, or one letter to another. Further, the indication of advancing from one Braille character/contraction to the next includes an indication of spaces and other punctuation. The rate of automated transcription can also be configured by a user.

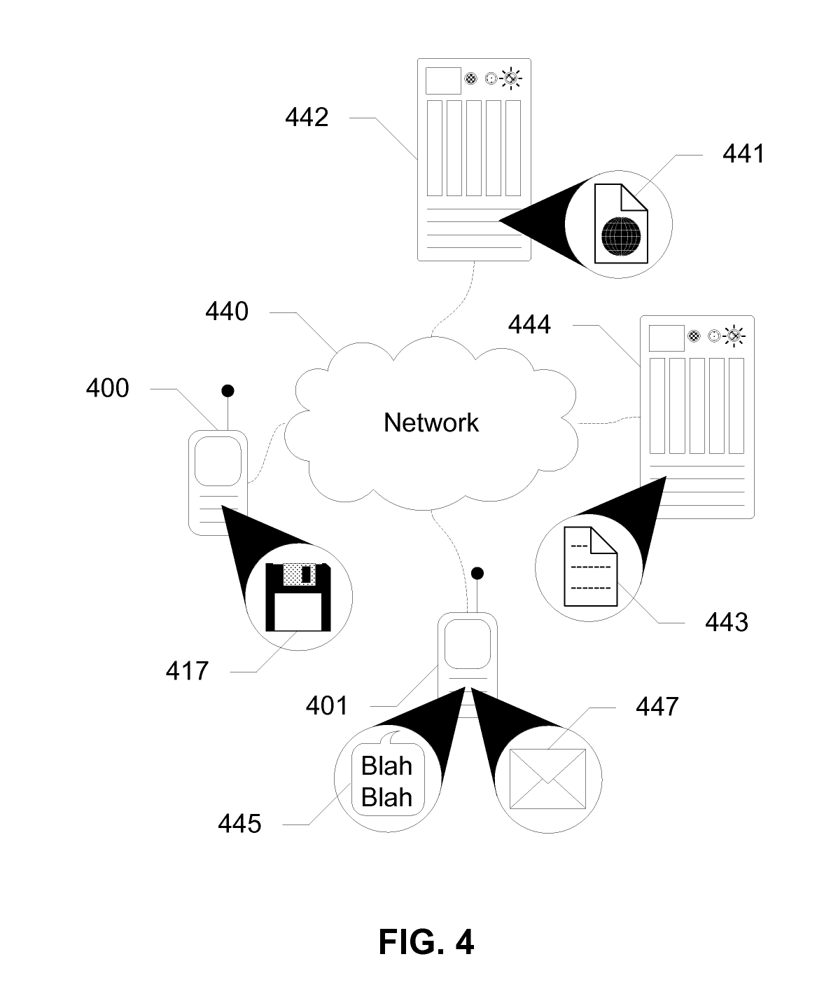

FIG. 4 shows a system for displaying Braille, according to an exemplary embodiment of the present invention. In this embodiment, the system includes a messaging device 400 having Braille messaging logic 417 embedded therein, a source device 401 generating or having therein a voicemail or a message 447, a web server 442 hosting a webpage or website 441, and a document server 444 storing or hosting a document 443. Devices 400-401 and servers 442, 444 communicate with each other via network 440. Webpage 441 can be accessed over network 440 by messaging device 400. Document 443 can be accessed over network 440 by messaging device 400. External messaging device 401 can send a voicemail 445 or a message 447, such as an e-mail, MMS, or SMS message, over network 440 to messaging device 400. Therefore, it is understood that network 440 includes several network elements not shown, which allow these devices and servers to communicate with each other. For instance, network 440 includes elements of cellular networks (base stations, SMSCs, etc.), as well as packet-based networks such as the INTERNET (gateways, switches, etc.). Similarly, devices 400-401 can communicate over cellular networks or the internet, and servers 442, 444 can be hosted by an operator of the network, an external service provider, or anywhere on the INTERNET. Other methods of communication between network elements will be apparent to one of ordinary skill in the art.

Messaging device 400 has an input, such as a touchscreen, a keypad, or a navigation pad, and actuators coupled to the input. Braille messaging logic 417 retrieves an alphanumeric string from webpage 441, document 443, message 447, or a transcribed voicemail. For instance, incoming text messages are received by a receiving portion of Braille messaging logic 445. Incoming voicemails are received by the receiving portion and are transcribed into text. Furthermore, webpage 441 and document 443 are accessible via an HTTP, FTP, or equivalent protocol. Each of these resources (messages, documents, or websites) is transcribed into Braille by a transcribing portion of Braille messaging logic. An alphanumeric string, such as a letter, number, sequence of letters, or word, is transcribed into a Braille character/contraction using methods known in the art, and stored temporarily or permanently on a memory on messaging device 400. A display portion of Braille messaging logic 417 defines a Braille cell on messaging device 400 using the methods described herein. For example, keys on a keypad, an area of a touchscreen, or pins within a navigation pad are configured as a Braille cell. The display portion of Braille messaging logic 417 further contains instructions to enable actuators to correspond to active bits of the transcribed Braille character, using the actuating mechanisms described herein. For instance, a key may be elevated/lowered or vibrated, sub-regions of a touchscreen change height or texture, or pins on a navigation pad change height to represent the active bits of the Braille character.

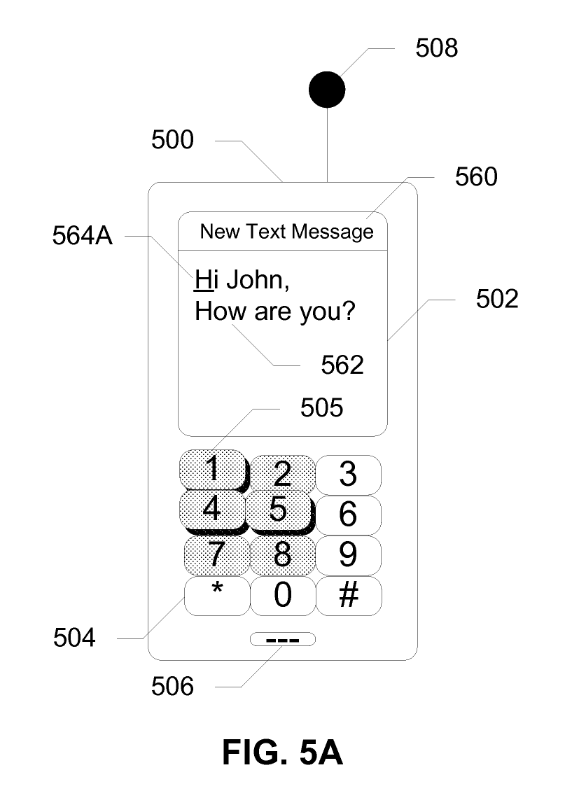

FIGS. 5A-5B show a messaging device 500 with a Braille cell on a keypad 504, according to an exemplary embodiment of the present invention. Messaging device 500 includes a screen 502, keypad 504 having keys 505, microphone 506, and antenna 508. Not shown are the inner components including a processor and memory, the memory having Braille display logic stored therein. The Braille display logic configures a plurality of keys on keypad 504 to simulate a Braille cell. In this embodiment, keys 1, 4, 7, 2, 5, and 8 constitute the six bits of a 6-bit Braille cell. The ‘*’ and ‘0’ keys can further constitute bits seven and eight of an 8-bit Braille cell.

Screen 502 shows a new text message application 560, indicating a message 562 received by messaging device 500. The application 560 displays on screen 502 a text message 562. Message 562 may be received via a network from another messaging device, or an equivalent network component. Message 562 states the following text: “Hi John, How are you?” Braille display logic on messaging device 500 translates an alphanumeric string 564 into Braille, and represents the corresponding Braille character using keys 505 of the Braille cell. Referring to FIG. 5A, the alphanumeric string 564A is the letter “H” from the word “Hi”. Alphanumeric string 564A is transcribed into Braille by actuating the numbered keys ‘1’, ‘4’, and ‘5’, using an actuator coupled to the keys as described herein. These keys correspond to active bits in the Braille transcription of the letter “H”. Consequently, digits ‘2’, ‘7’, and ‘8’ represent inactive or passive bits. A user can sense the actuated keys with their fingertip, and is able to read the Braille transcription of the letter “H”. Alphanumeric string 564A may be underlined or highlighted on screen 502, enabling one with limited sight to see which letter or word is being transcribed. Referring to FIG. 5B, alphanumeric string 564B is the second letter, “i”, of the word “Hi”, and is transcribed to the Braille cell on keypad 504. The letter “i”, for instance, corresponds to the actuated keys ‘2’ and ‘4’, while keys ‘1’, ‘5’, ‘7’, and ‘8’ represent passive bits of the Braille character for “i”. Thus the user has read the word “Hi” as transcribed in Braille.

The actuation of the keys 505 is accomplished by the methods shown above, including raising keys corresponding to active bits, depressing keys corresponding to inactive bits, vibrating keys corresponding to active bits, and combinations thereof. Further, switching from one letter to the next (or one word to the next) can be indicated by several means, such as displaying a blank Braille cell having all inactive bits, or via a sound or a mechanical vibration emitted by messaging device 500. Other means for indicating the progression to a new character or word will be evident to one skilled in the art in light of this disclosure. The present invention also allows for a user to manually advance the transcription to the next letter or word. For instance, after reading the letter “H” the user may push a button on keypad 504 or state a voice command to advance the transcription to the letter “i”. Other combinations of automatic and manual advancement are possible. Moreover, it should be noted that the transcription shown in FIGS. 5A-5B is merely exemplary in nature, and does not limit the messaging device to transcribe only letters. A transcription of the entire word “Hi” can be represented by a single Braille character, the Braille character being a contraction.

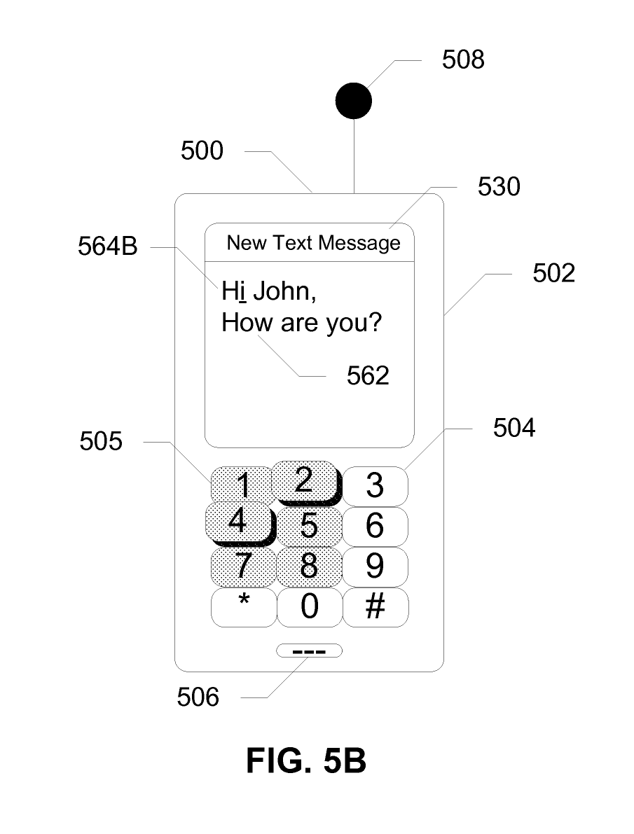

FIG. 6 shows a Braille transcription on a virtual keypad 604 of a messaging device 600, according to an exemplary embodiment of the present invention. Messaging device 600 is shown transcribing a text message into a Braille cell on virtual keypad 604. Messaging device 600 includes a touchscreen 602, upon which is displayed virtual keypad 604 having virtual keys 605, a microphone 606, and an antenna 608. Not shown are the inner components including a processor and memory, the memory having Braille display logic stored therein. The Braille display logic configures a plurality of keys 605 on virtual keypad 604 to simulate a Braille cell. In this embodiment, keys ‘1’, ‘4’, ‘7’, ‘2’, ‘5’, and ‘8’ constitute the six bits of a 6-bit Braille cell. The ‘*’ and ‘0’ keys can further constitute bits seven and eight of an 8-bit Braille cell.

Touchscreen 602 shows a new text message notification received by messaging device 600. The new text message may be received via a network from another messaging device, or an equivalent network component. The text message states the following text: “Hi John, How are you?” Logic on messaging device 600 transcribes an alphanumeric string from the text message into a Braille character, and represents the Braille character on virtual keypad 604 using the defined Braille cell. This representation is achieved by actuators coupled to or located underneath touchscreen 602. Particularly, a plurality of actuators is arranged as a grid underneath virtual keypad 604 portion of touchscreen 602. There can be several actuators underneath each virtual key 605. The actuators actuate the keys by raising the surface or sub-region of the surface of touchscreen 602 that corresponds to virtual keys 605, such that a tactile sensation is experienced by a user's finger touching touchscreen 602. For instance, the actuators may vary the texture above a virtual key. Actuated virtual keys ‘1’, ‘4’, and ‘5’ are shown to correspond to active bits in the Braille transcription of the letter “H”. Consequently, digits ‘2’, ‘7’, and ‘8’ represent inactive or passive bits. A user can sense the actuated virtual keys 605 with their fingertip, and is able to read the Braille transcription of the letter “H”. The letter “H” may be underlined or highlighted on the screen, enabling one with limited sight to see which letter or word is being transcribed.

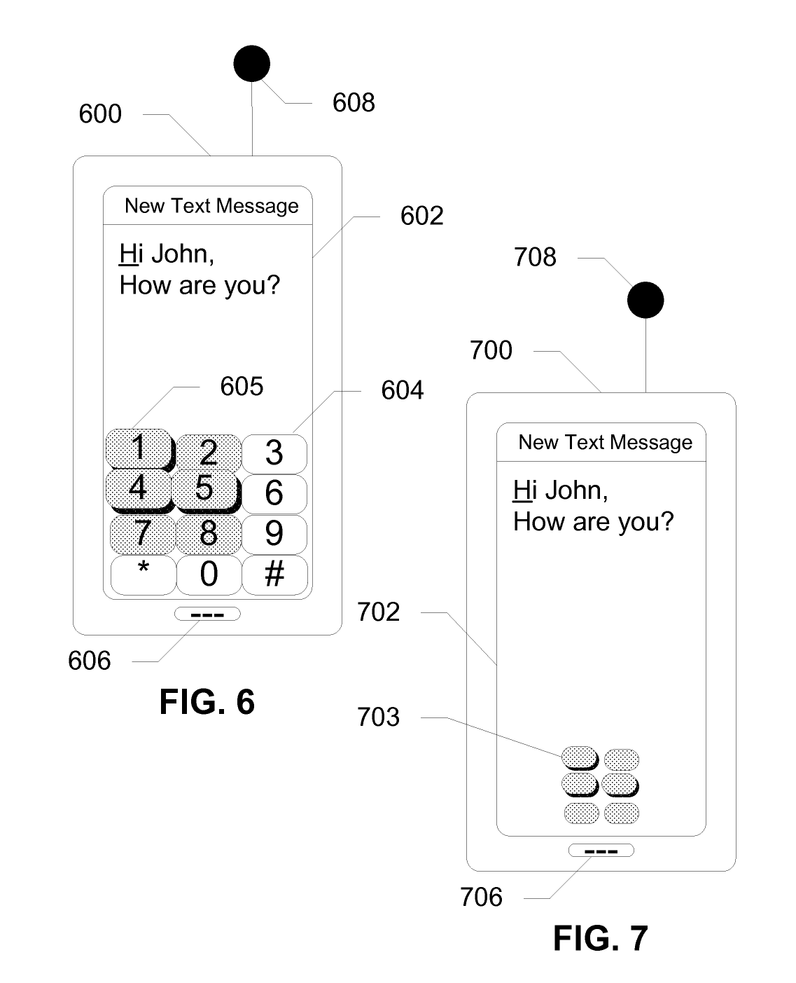

As an alternative, FIG. 7 shows a Braille transcription on a Braille cell region on a touchscreen 702 of a messaging device 700, according to an exemplary embodiment of the present invention. Messaging device 700 is shown transcribing a text message into a Braille cell 703 on touchscreen 702. Notably, Braille cell 703 is not part of a keypad, but is simply defined on a Braille cell region of touchscreen 702. This region may be situated anywhere on the touchscreen that provides convenient access for a user's fingertips. Messaging device 700 further includes a microphone 706, and antenna 708. Not shown are the inner components including a processor and memory, the memory having Braille display logic stored therein. Touchscreen 702 shows a new text message notification received by messaging device 700. The new text message may be received via a network from another messaging device, or an equivalent network component. The text message states the following text: “Hi John, How are you?” Logic on messaging device 700 transcribes an alphanumeric string from the text message into a Braille character, and represents the Braille character on the Braille cell region of touchscreen 702. The Braille display logic configures a region on touchscreen 702 to simulate Braille cell 703. Six sub-regions within Braille cell 703 constitute six bits of a Braille cell, and can be actuated by a plurality of actuators coupled within or underneath the Braille cell region of touchscreen 702. The sub-regions can be raised or lowered to vary the tactile sensation experienced by a user attempting to read the Braille transcription. For instance, the letter “H” is transcribed into the Braille character displayed by Braille cell 703. The letter “H” may be underlined or highlighted on the screen, enabling one with limited sight to see which letter or word is being transcribed. Since touchscreen 702 is also an input device, the user may manually advance the progression by pushing touchscreen 702 with their fingertip, or by any of the other means described herein.

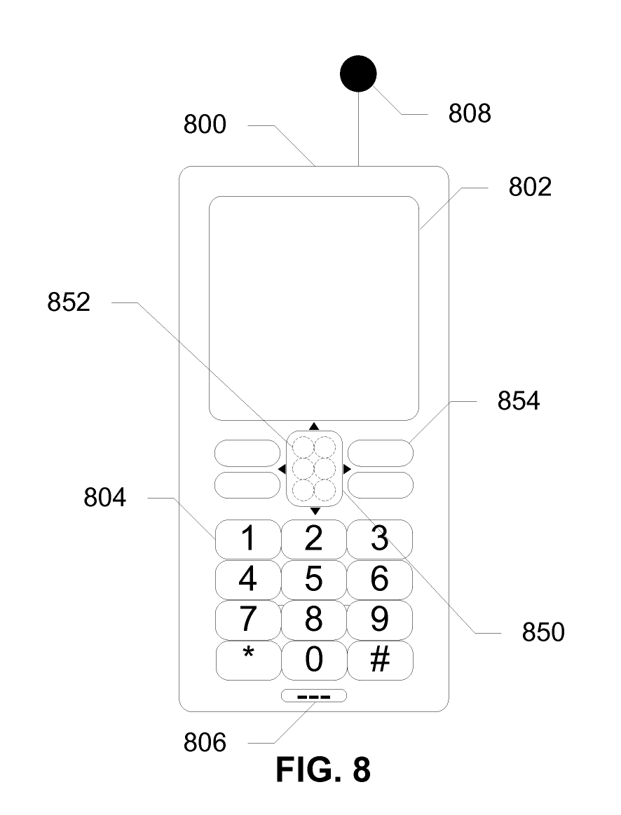

FIG. 8 shows a Braille cell on a navigation pad 850 of a messaging device 800, according to an exemplary embodiment of the present invention. Messaging device 800 includes a screen 802, a keypad 804, a microphone 806, an antenna 808, navigation pad 850, navigation pad pins 852, and soft keys 854. Not shown are the inner components including a processor and memory, the memory having Braille display logic stored therein. Navigation pad 850 is typically used as an input device (for instance, to navigate a cursor on screen 802), however the present invention provides for the navigation pad 850 to be used as an output device. Particularly, the Braille display logic configures pins 852 on navigation pad 850 to simulate a Braille cell. In this embodiment, six pins 852 constitute the six bits of a Braille cell. Braille display logic on messaging device represents a Braille character transcribed from an alphanumeric string on navigation pad 850 using one or more actuator coupled to each navigation pad pin 852. The actuators actuate pins 852 by elevating, lowering, or vibrating pins 852, similar to the embodiment with the keys. Actuated pins represent active bits of a Braille character. Navigation pad 850 is ideally situated and sized such that a user's finger can be placed upon navigation pad 850 such that a tactile sensation is experienced by the user while reading an incoming alphanumeric string. The user can advance the Braille display/transcription by pushing one of soft keys 854. Alternatively, navigation pad 850 is touch-sensitive, and the user can advance the transcription simply by pushing down on pins 852, or via a sensor such as a capacitance sensor incorporated into navigation pad 850.

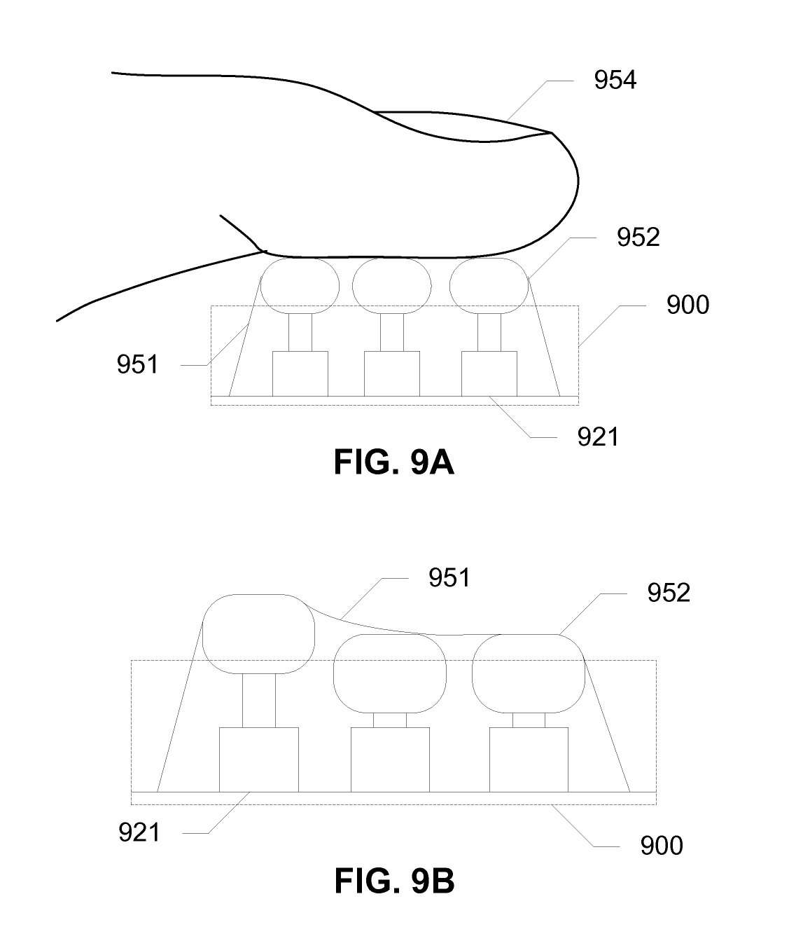

FIGS. 9A-9B show the elements of a navigation pad on a messaging device 900, according to an exemplary embodiment of the present invention. The navigation pad includes several navigation pad pins 952, each coupled to an actuator 921, enclosed within a navigation pad casing 951. Navigation pad casing 951 extends above a top cover or faceplate of messaging device 900, represented by the dotted box. Although three pins 952 are shown, it should be understood that FIGS. 9A-9B show a side view of navigation pad 950, and therefore there are at least six or eight pins, depending on the number of bits used in the Braille system. A user's thumb 954 rests on casing 951. FIG. 9A shows three pins 952 in an elevated state. FIG. 9B shows one elevated pin, corresponding to an active bit, and two depressed pins, corresponding to a passive bit of a Braille character. These pins therefore represent active bits of a Braille character, able to be sensed by thumb 954. Thumb 954 senses a height difference in casing 951, thereby allowing a sight-impaired user to read the Braille character.

Actuator 921 may either be an elevating actuator, or a depressing actuator. In FIG. 9A, the actuated pins may be raised by an elevating actuator, or simply left in a default elevated state if the actuator is a depressing actuator. Similarly, the elevated pin in FIG. 9B could be elevated by an elevating actuator, or the depressed pins could be lowered by a depressing actuator. Combinations of the two types of actuators are possible. Furthermore, similar embodiments use vibrating actuators either alone or in combination with elevating/depressing actuators to display a Braille character.

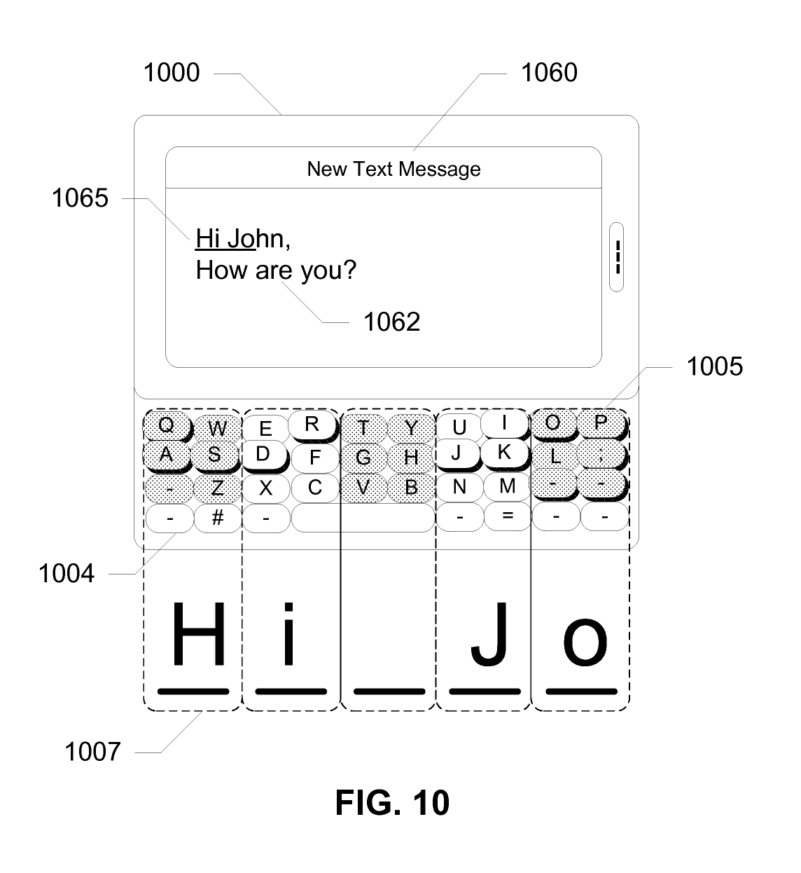

FIG. 10 shows a messaging device 1000 with multiple Braille cells 1007 defined on a QWERTY keyboard 1004, according to an exemplary embodiment of the present invention. Messaging device 1000 is shown transcribing an alphanumeric string 1065 into five Braille cells 1007 defined on keyboard 1004. Messaging device 1000 includes a screen 1002, and a keyboard 1004 having keys 1005. Not shown are the inner components including a processor and memory, the memory having Braille display logic stored therein. The Braille display logic configures keys 1005 on keyboard 1004 to simulate Braille cells 1007. In this embodiment, keys ‘Q’, ‘A’, (period), ‘W’, ‘S’, and ‘Z’ constitute the six bits of the first Braille cell. The ‘-’ and ‘#’ keys can further constitute bits seven and eight of an 8-bit Braille cell. Similarly, keys ‘E’, ‘D’, ‘X’, ‘R’, ‘F’, and ‘C’ constitute a second adjacent Braille cell, and so on. The present embodiment shows five Braille cells 1007 defined on keyboard 1004, however, other configurations are possible. Five Braille cells 1007 allow up to five Braille characters to be displayed on keyboard 1004 at one time, thereby increasing the reading speed of a user.

Screen 1002 shows a new text message notification 1060 received by messaging device 1000. Notification 1030 is accompanied by a text message 1062. Text message 1062 may be received via a network from another messaging device, or an equivalent network component. Text message 1062 states the following text: “Hi John, How are you?” A portion of text message 1062 includes alphanumeric string 1065, which states: “Hi Jo”, and logic on messaging device 1000 transcribes alphanumeric string 1065 into Braille. The corresponding transcription includes five Braille characters, each of which can be represented by a corresponding Braille cell of five Braille cells 1007 on keyboard 1004. For instance, the letter “H” from the word “Hi” is transcribed into Braille by actuating the keys ‘Q’, ‘A’, and ‘S’, using an actuator coupled to the keys as described herein. These keys correspond to active bits in the Braille transcription of the letter “H”. Consequently, keys (period), ‘W’, and ‘Z’ represent inactive or passive bits. A user can sense the actuated keys with their fingertip, and is able to read the Braille transcription of the letter “H”. The second letter of the word “Hi” is represented on the second Braille cell, by actuating the keys ‘R’, and ‘D’. The space between “Hi” and “Jo” may be represented by allowing all the keys in the third Braille cell to remain in a passive state. Similarly, the remaining letters in alphanumeric string 1065 are represented on each of the remaining defined Braille cells on keypad 1004. Thus the user is able to quickly read a larger alphanumeric string as transcribed in Braille. Alphanumeric string 1065 may be underlined or highlighted on the screen, enabling one with limited sight to see which letter, combination of letters, or word is being transcribed.

The actuation of keys 1005 is accomplished by the methods shown above, including raising keys corresponding to active bits, depressing keys corresponding to inactive bits, vibrating keys corresponding to active bits, and combinations thereof. Further, switching from one letter to the next (or one word to the next) can be indicated by several means, such as displaying a blank Braille cell having all inactive bits, or via a sound or a mechanical vibration emitted by messaging device 1000. Other means for indicating the progression to a new character or word, or to manually advance the progression, have been described herein.

It should be noted that the transcription shown in FIG. 10 is merely exemplary in nature, and does not limit the messaging device to transcribe only letters. A transcription of the entire word “Hi” can be represented by a single Braille character, the Braille character being a contraction. Furthermore, any transcription into Braille may be accompanied by a text-to-speech transcription for easier reading.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A messaging device comprising:
a processor;
a memory in communication with the processor;
a plurality of keys on a keypad in communication with the processor;
an actuator coupled to each of the plurality of keys; and
a Braille display logic on the memory, wherein the Braille display logic defines the plurality of keys as a Braille cell, each key representing a bit of the Braille cell, and actuates a key corresponding to an active bit of a Braille character.

2. The messaging device of claim 1, wherein the plurality of keys is arranged as a grid.

3. The messaging device of claim 1, wherein the Braille character is a Braille contraction.

4. The messaging device of claim 1, wherein the Braille character is transcribed from an alphanumeric string retrieved from a message.

5. The messaging device of claim 4, wherein the message is any one of a text message, short message, e-mail, website, and document.

6. The messaging device of claim 1, wherein the actuator elevates the key corresponding to the active bit.

7. The messaging device of claim 1, wherein the actuator vibrates the key corresponding to the active bit.

8. The messaging device of claim 1, wherein the keypad is a virtual keypad on a touchscreen, and wherein the actuator is coupled to the touchscreen.

9. A method for displaying Braille on a messaging device having a keypad, the method comprising:
defining a Braille cell on the keypad, each key on the keypad representing a bit of the Braille cell; and
actuating a key corresponding to an active bit of a Braille character.

10. The method of claim 9, wherein defining the Braille cell includes arranging the Braille cell across a grid of keys.

11. The method of claim 9, further comprising transcribing a Braille character from an alphanumeric string.

12. The method of claim 11, further comprising retrieving the alphanumeric string from one of a text message, short message, e-mail, website, and document.

13. The method of claim 9, wherein actuating the key further comprising elevating the key.

14. The method of claim 9, wherein actuating the key further comprises vibrating the key.

15. The method of claim 9, further comprising actuating a virtual key corresponding to an active bit of the Braille character, wherein the virtual key is displayed on a touchscreen coupled to the messaging device.

16. A system for displaying Braille, comprising:
a network;
a source device on the network, the source device having an alphanumeric string;
a messaging device on the network, the messaging device including a plurality of keys on a keypad, and an actuator coupled to each of the plurality of keys; and
Braille messaging logic on the messaging device that retrieves the alphanumeric string, transcribes a Braille character from the alphanumeric string, defines the plurality of keys as a Braille cell, and actuates a key corresponding to an active bit of the Braille character.

17. The system of claim 16, wherein the alphanumeric string is a portion of any one of a text message, short message, e-mail, website, and document.

18. The system of claim 16, wherein the actuator elevates the key corresponding to the active bit.

19. The system of claim 16, wherein the actuator vibrates the key corresponding to the active bit.

20. The system of claim 16, wherein the keypad is a virtual keypad on a touchscreen, and wherein the actuator is coupled to the touchscreen.
